(19) United States
(12) Patent Application Publication
(10) Pub. No.: US 2026/0167516 A1
(43) Pub. Date: Jun. 18, 2026

(54) MICRON-SIZED POROUS SODIUM FERROUS SULFATE/CARBON COMPOSITE POSITIVE ELECTRODE MATERIAL AND SODIUM ION BATTERY OR SODIUM BATTERY PREPARED FROM SAME

(71) Applicant: ZHENGZHOU UNIVERSITY, Zhengzhou, Henan Province (CN)

(72) Inventors: Weihua CHEN, Zhengzhou (CN); Jiyu ZHANG, Zhengzhou (CN); Yongliang YAN, Zhengzhou (CN); Mingrui YANG, Zhengzhou (CN)

(21) Appl. No.: 18/710,617

(22) PCT Filed: Dec. 22, 2021
(86) PCT No.: PCT/CN2021/140464

§ 371 Date: May 16, 2024

(30) Foreign Application Priority Data
Nov. 16, 2021 (CN) 202111356573.4

(51) Int. Cl. C01G 49/00; H01M 4/02; H01M 4/04; H01M 4/136; H01M 4/38; H01M 4/58; H01M 4/62; H01M 4/66; H01M 10/054; H01M 10/0568; H01M 10/0569

(52) U.S. Cl. CPC C01G 49/009; H01M 4/0404; H01M 4/136; H01M 4/381; H01M 4/5825; H01M 4/623; H01M 4/625; H01M 4/661; H01M 10/054; H01M 10/0568; H01M 10/0569; C01P 2002/54; C01P 2002/72; C01P 2004/03; C01P 2004/61; C01P 2004/84; C01P 2006/40; H01M 2004/021; H01M 2004/027; H01M 2004/028; H01M 2300/0037

(57) ABSTRACT

The invention discloses a kind of micrometer-scale porous sodium ferrous sulfate/carbon composite cathode materials and sodium-ion or sodium batteries with it. The materials are prepared by a co-precipitation and solid-phase calcination method, and/or involve the metal-doped elements. The materials feature a porous structure with a three-dimensional conductive network, and have a size distribution (2-30 μm) of particles, consisting of a close stack of primary particles of 80-200 nm tightly covered by an amorphous carbon. Micrometer-scale cathode materials deliver a high vibration density, which helps to improve the volumetric energy density of batteries. As a cathode for sodium-ion or sodium batteries, the materials have the advantages of abundant raw materials, low cost, high operating voltage, good rate performance and cycling stability, and simple preparation process. The assembled sodium-ion or sodium batteries show a broad market application prospect with the advantage of high energy density.

### TECHNICAL FIELD

The present invention relates to the technical field of positive electrode materials for sodium ion batteries. It particularly relates to micron-sized porous sodium ferrous sulfate/carbon composite positive electrode materials that can be charged and discharged with sodium ions, and to high-voltage, high-power sodium ion batteries or sodium batteries comprising such materials.

### BACKGROUND ART

As a medium for energy transport between renewable energy sources and large-scale energy storage systems, sodium ion batteries are regarded as one of the most promising next-generation energy storage systems due to their abundant resource reserves, low cost and other advantages. However, the existing sodium ion battery technology does not meet the requirements of new technology applications which are oriented to the needs of large-scale energy storage power stations and new energy trams, especially the positive electrode's cost and energy density. Therefore, the development of sodium ion batteries with low cost, high energy density, high power density and long cycle life has become an urgent need.

In sodium ion battery systems, the positive electrode material largely determines the cycling stability of the energy density of the battery device. Compared with typical positive electrode materials (iron-based phosphate, Prussian blue analogues, and ternary layered oxide), alluaudite-type Na₂₊₂ₓFe₂₋ₓ(SO₄)₃ materials with high elemental reserves, low cost and high operating voltage platform, can provide high energy density for batteries, and is one of the sodium-storage positive electrode materials with better prospects for large-scale application. However, their kinetic properties are poor, resulting in serious polarization at large current, low discharged specific capacity, and poor cycle stability.

Literature has been developed to solve the above problems mainly by designing the nanoparticles' structure and their composites with carbon materials. However, nanomaterials with high specific surface area decrease the density of the positive electrode; meanwhile, the nano-sized particles of active materials are prone to structural agglomeration during the Na⁺ extraction/insertion process, which damages the long-term cycle stability of the battery.

### SUMMARY OF THE INVENTION

In response to the above technical problems, the present invention proposes a micron-sized porous sodium ferrous sulfate/carbon composite positive electrode material and a sodium ion battery or sodium battery prepared from same. The micron-sized porous sodium ferrous sulfate/carbon composite particles are prepared by co-precipitation and solid-phase calcination, which have excellent structural stability, ionic conductivity, and elevated compaction density of the positive electrode. The sodium ferrous sulfate/carbon composites can be further doped with metal elements for material modification, and the assembled rechargeable sodium ion batteries or sodium batteries exhibit excellent rate performance and long-cycle stability.

### TECHNICAL SOLUTIONS OF THE INVENTION

A micron-sized porous sodium ferrous sulfate/carbon composite positive electrode material, the micron-sized porous sodium ferrous sulfate/carbon composite positive electrode materialshave a particle size of 2-30 μm, the particles have a porous structure and comprise a tightly packed stack of primary nanoparticles of 80-200 nm; the primary nanoparticles are tightly packed by amorphous carbon, the surface layer of the particles are covered with a thin layer of reduced graphene; the total mass of graphene/carbon is 4%-18.5% of the mass of the sodium ferrous sulfate/carbon composite positive electrode material.

Further, a metal element may be doped within the sodium ferrous sulfate/carbon composite positive electrode material, the doped metal elements are one or more of the Co, Ni, Mn, Cu or Al.

A method for preparing a micron-sized porous sodium ferrous sulfate/carbon composite positive electrode material, comprises the following steps:
(1) The preparation of precursors by co-precipitation method: A certain proportion of ethylene glycol and graphene oxide powder were dispersed into deionized water, and the obtained dispersion solution was ultrasonic treated for 15-120 minutes. Then, a certain proportion of anhydrous sodium sulfate, ferrous sulfate heptahydrate, antioxidants and organic carbon sources were added to the dispersion solution, and stirred for 30-120 min. Then organic alcohols were added to the dispersion solution drop by drop, and stirred for 10-120 min. The obtained turbid solution was centrifuged and freeze-dried to obtain the precursor. Or, a certain proportion of ethylene glycol and graphene oxide powder were dispersed into deionized water, and the obtained dispersion solution was ultrasonic treated for 15-120 minutes. Then, a certain proportion of anhydrous sodium sulfate, ferrous sulfate heptahydrate, antioxidants, organic carbon sources and metal dopants were added to the dispersion solution, and stirred for 30-120 min. Then organic alcohols were added to the dispersion solution drop by drop, and stirred for 10-120 min. The obtained turbid solution was centrifuged and freeze-dried to obtain the precursor.
(2) The preparation of composite positive electrode materialsby solid-phase calcination: the precursors obtained in step (1) were ground uniformly and placed in a tube furnace with an inert atmosphere for pre-calcination, then elevated to 300-450° C. for calcination for 8 -48 h, to obtain micron-sized porous sodium ferrous sulfate/carbon composite positive electrode material.

The micron-sized porous sodium ferrous sulfate/carbon composite positive electrode materialswere prepared by co-precipitation and solid-phase calcination. The added organic alcohol acted as a precipitant to promote the co-precipitation of the precursor mixtures, while the ethylene glycol with high viscosity and high surface tension inhibited the growth of the precipitated particles; the particles of the composite positive electrode materialshad a size distribution of 2-30 μm and a porous structure, which was formed by the tightly stacked primary particles of 80-200 nm; the organic carbon source added in the co-precipitation process evenly covered the precipitated nano-sized precursor particles with small molecular structure, and formed a continuous carbon layer in the subsequent solid-phase calcination process, inhibiting the growth of sodium ferrous sulfate crystal particles; meanwhile, the gas generated by the pyrolysis of the organic carbon source contributed to in-situ construct the three-dimensional porous structure between the microparticles; the insoluble graphene oxide flake layer can provide abundant precipitation sites and attach or coat the surface layer of the micron-sized precursor particles during continuous stirring, which is subsequently thermally reduced; the surface layer of the composite positive electrode material particles is uniformly wrapped by a thin layer of reduced graphene, the internal primary particles are tightly coated by amorphous carbon, where the total mass of the graphene/carbon is 4%-18.5% of the mass of the sodium ferrous sulfate/carbon composite positive electrode material.

Preferably, the mass ratio of deionized water, ethylene glycol and graphene oxide in step (1) is 1000:(200-750):(0.1-1), the molar ratio of anhydrous sodium sulfate, ferrous sulfate heptahydrate, an organic carbon source and an antioxidant is 1:1:(0-0.4):(0.01-0.05), the organic carbon source is one or several of citric acid monohydrate, glucose and polyethylene glycol, the metal dopant is a sulfate containing metal ions, including manganese sulfate, nickel sulfate, cobalt sulfate, copper sulfate, aluminum sulfate and one or several of their hydrates; or the mass ratio of deionized water, ethylene glycol, and graphene oxide in step (1) is 1000:(200-750):(0.1-1); the molar ratio of anhydrous sodium sulfate, ferrous sulfate heptahydrate, organic carbon source, the antioxidant and the metal dopant is 1:(0.9-1):(0-0.4):(0.01-0.05):(0-0.1); the organic carbon source is one or more of citric acid monohydrate, glucose, and polyethylene glycol; the metal dopant is one or more of sulfate salt containing metal ions, including manganese sulfate, nickel sulfate, cobalt sulfate, copper sulfate, aluminum sulfate, and their hydrates.

Preferably, in step (1), the antioxidant is one or more of ascorbic acid, pyrrole, and hydroquinone; the volume ratio of the organic alcohol to deionized water is (1.5-5.0):1; the organic alcohol is one or more of isopropanol, anhydrous ethanol, n-butanol, tertiary-butanol, propanetriol, triethylene glycol; the centrifugation is performed at a rate of 6,000-9,500 r/min for a period of 1 to 10 min, the freeze-drying time was 12-36 h. The results are summarized in the following table.

Preferably, in step (2), the inert atmosphere is nitrogen, argon, or an argon-hydrogen mixture; the pre-calcination process is heating to 100-300° C. at a heating rate of 1-5° C./min at a constant temperature of 0.5-3 h; the calcining process is heating to 350-400° C. at a heating rate of 1-3° C./min at a constant temperature of 8 -48 h.

A kind of sodium ion batteries or sodium batteries prepared by micron-sized porous sodium ferrous sulfate/carbon composite positive electrode materials, comprising a positive electrode sheet, an negative electrode sheet, an electrolyte, a separator, and a casing. The micron-sized porous sodium ferrous sulfate/carbon composite positive electrode materialsare the active material in positive electrode, and the active materials with Na⁺ extraction/insertion capability were used as the negative electrode of sodium ion batteries, or sodium metal was used as the negative electrode of sodium batteries. The separator was one of the modified cellulose acetate membranes, polyethylene, polypropylene microporous membranes, glass fiber membranes or their composite membranes, and the electrolyte was soluble sodium salt organic solution.

Preferably, the positive electrode sheet of the sodium batteries is obtained by filling and coating the collector with a slurry obtained by uniformly mixing the positive electrode material with the conductive agent, the binder and the dispersant; the collector is aluminum foil. The positive electrode sheet of the sodium ion batteries is obtained by filling and coating the collector with a slurry obtained by uniformly mixing the positive electrode material with the conductive agent, the binder and the dispersant; the collector is aluminum foil; the negative electrode sheet is obtained by filling and coating the collector with a slurry obtained by uniformly mixing the negative electrode material with the conductive agent, the binder and the dispersant, the collector being aluminum foil or copper foil.

Preferably, the conductive agent of the sodium ion batteries or the sodium batteries is one or more of acetylene black, Super P, or graphite; the binder of the sodium ion batteries or the sodium batteries is one or more of polytetrafluoroethylene, polyvinylidene fluoride, or styrene-butadiene rubber; the dispersant of the sodium ion batteries or the sodium batteries is one or more of anhydrous ethanol, isopropanol, or 1-methyl-2-pyrrolidone.

Preferably, the negative electrode of the sodium ion batteries is an active material with with Na⁺ extraction/insertion capability, including carbon materials, metal sulfides, metal oxides, and alloy compounds; the soluble sodium salt organic solution is obtained by dissolving the sodium salt in organic solvents, the sodium salt is one or more of sodium hexafluorophosphate, sodium perchlorate, and sodium trifluoromethyl sulfonate, the organic solvent is one or more of ethylene carbonate (EC), propylene carbonate (PC), fluoroethylene carbonate (FEC), dimethyl carbonate, diethyl carbonate, diglycol dimethyl ether, 1,3-cyclopentanediol, ethylene glycol dimethyl ether, and triglycerol dimethyl ether.

Preferably, the casing of the sodium ion batteries or sodium batteries is made of organic plastic, aluminum casing, aluminum-plastic film, stainless steel, or composites thereof.

Preferably, the shape of the sodium ion batteries or sodium batteries may be button, column or square.

### BENEFICIAL EFFECTS OF THE PRESENT INVENTION

1. The micron-sized porous sodium ferrous sulfate/carbon composite positive electrode materialsin the present invention have novel and unique morphological features: the micron-sized porous sodium ferrous sulfate/carbon composite positive electrode material, including sodium ferrous sulfate/carbon composites with and/or without doped metal elements, have a micron-sized, porous bulk structure of particles. Robust micron-sized bulk and an effective carbon encapsulation structure strengthen the structural stability of the composite material; the micron-sized particles of sodium ferrous sulfate/carbon composites are assembled by nanoscale sodium ferrous sulfate primary nanoparticles in an orderly manner, and the nanoscale particles shorten the path of Na⁺ transport, reduce the concentration polarization, successfully enhancing the ion diffusion rate of the material; the multilevel conductive network constructed by the uniform coating of amorphous carbon and the high dispersion of graphene enhances the electronic conductivity of the composites; suitable doped metal cation helps improve the surface stability of the positive electrode material. As a result, the micron-sized porous sodium ferrous sulfate/carbon composite positive electrode materialshave the advantages of low electrode cost, abundant raw material reserves, high operation voltage, good rate performance and cycling stability, the rechargeable sodium ion batteries or sodium batteries containing the material have high energy density and power density.
2. The present invention adopts a micron-sized porous sodium ferrous sulfate/carbon composite positive electrode material as the positive electrode for sodium ion batteries or sodium batteries, which helps to improve the density of the positive electrode and the volumetric energy density of the batteries. The sodium ferrous sulfate/carbon composite positive electrode materialshave a particle size range of 2-30 μm, porous structure, and consist of a stack of primary particles of 80-200 nm; amorphous carbon is tightly encapsulated in the internal primary nanoparticles, and a thin layer of graphene is covered on the surface layer of the micrometer particles, constituting a three-dimensional conductive network to improve the electronic/ionic diffusion kinetics and electrochemical stability of the composite material. The prepared composite positive electrode materialshave low cost, abundant raw materials, high operation voltage, good rate performance and cycle stability. And their preparation processes are simple, easy to scale up and green. The sodium ion batteries or sodium batteries that can be charged and discharged with sodium ions containing this material have low cost, high energy density and power density, and long cycle stability, showing a broad market application prospect.

### BRIEF DESCRIPTION OF DRAWINGS

In order to more clearly illustrate the technical solutions in the embodiments or prior art of the present invention, the accompanying drawings to be used in the description of the embodiments or prior art will be briefly introduced below, it will be obvious that the accompanying drawings in the following description are only some of the embodiments of the present invention, and that for the person of ordinary skill in the field, other attachments can be obtained based on the accompanying drawings without creative labor.

FIG. 1 is the XRD pattern of the micron-sized porous sodium ferrous sulfate/carbon composite positive electrode material prepared according to Example 1.

FIG. 2 is a SEM image of the precursor prepared according to Example 1.

FIG. 3 is a SEM image of the micron-sized porous sodium ferrous sulfate/carbon composite positive electrode material prepared according to Example 1.

FIG. 4 is a high-resolution SEM image of the micron-sized porous sodium ferrous sulfate/carbon composite positive electrode material prepared according to Example 1.

FIG. 5 is a charge-discharge curve graph of the sodium battery according to Example 1.

FIG. 6 is a rate performance graph of sodium battery according to Example 1

FIG. 7 is a cycling performance graph of sodium battery according to Example 1.

FIG. 8 is a charge-discharge curve graph of the sodium ion battery according to Example 2.

FIG. 9 is a charge-discharge curve graph of the sodium ion battery according to Example 3.

FIG. 10 is a charge-discharge curve graph of the sodium battery according to Example 4.

FIG. 11 is a SEM image of the micron-sized porous sodium ferrous sulfate/carbon composite positive electrode material prepared according to Example 5.

FIG. 12 is a charge-discharge curve graph of the sodium battery according to Example 5.

FIG. 13 is a charge-discharge curve graph of the sodium battery according to Example 6.

FIG. 14 is a charge-discharge curve graph of the sodium battery according to Example 7.

FIG. 15 is a charge-discharge curve graph of the sodium battery according to Example 8.

FIG. 16 is a charge-discharge curve graph of the sodium battery according to Example 9.

FIG. 17 is a charge-discharge curve graph of the sodium battery according to Example 12.

FIG. 18 is a charge-discharge curve graph of the sodium battery according to Example 13.

### DETAILED DESCRIPTION OF THE INVENTION

The technical solutions in the embodiments of the present invention will be described clearly and completely in the following in conjunction with the accompanying drawings in the embodiments of the present invention. It is obvious that the described embodiments are only a part of the embodiments of the present invention and not all of the embodiments. Based on the embodiments in the present invention, all other embodiments obtained by a person of ordinary skill in the art without creative labor fall within the scope of protection of the present invention.

### Example 1

The synthesis steps of the micron-sized porous sodium ferrous sulfate/carbon composite positive electrode material used in the present invention are as follows: 0.02 g of dry graphene oxide powder was dispersed into the mixture of 20 ml of deionized water and 10 mL of ethylene glycol. The solution was stirred for 1 h, and ultrasonicated for 15 min to disperse the graphene oxide. 1.112 g of ferrous sulfate heptahydrate (FeSO₄·7H₂O), 0.5682 g of anhydrous sodium sulfate (Na₂SO₄), 0.2 g of citric acid monohydrate, 0.02 g of ascorbic acid were dissolved in the above graphene oxide dispersion, and stirred for 1 h at room temperature (25° C.). 40 ml of isopropanol was added dropwise to the above solution to obtain a turbid suspension, and the suspension was stirred for another 1 h. The turbid suspension was centrifuged (centrifugation rate of 8500 r/min, centrifugation time of 3 min), the obtained solid was frozen by liquid nitrogen and then freeze-dried for 36 h to obtain the precursor. The precursor was ground uniformly, transferred to a ceramic cup, and placed in a tube furnace with argon atmosphere at a heating rate of 3° C./min to 200° C. for 2 h, adjusted the heating rate of 1° C./min, and then heated to 350° C. for 12 h, to obtain the micron-sized porous sodium ferrous sulfate/carbon composite positive electrode materials.

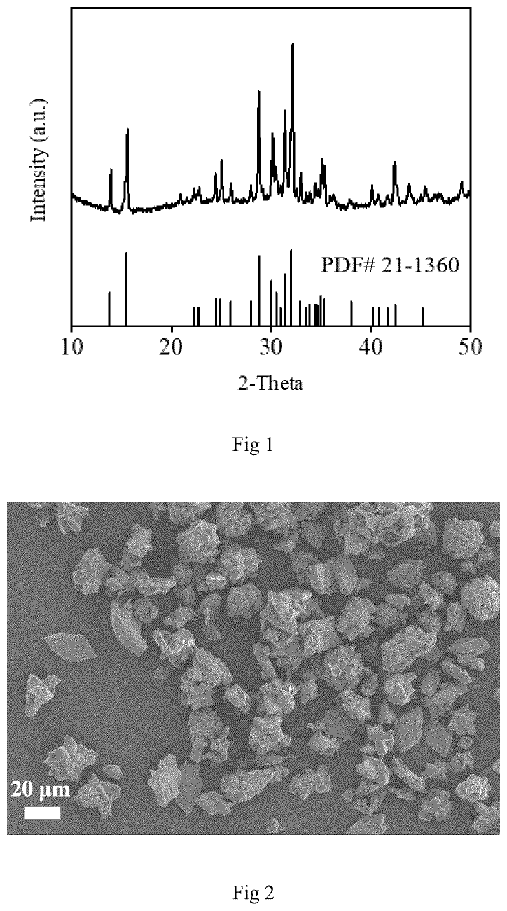

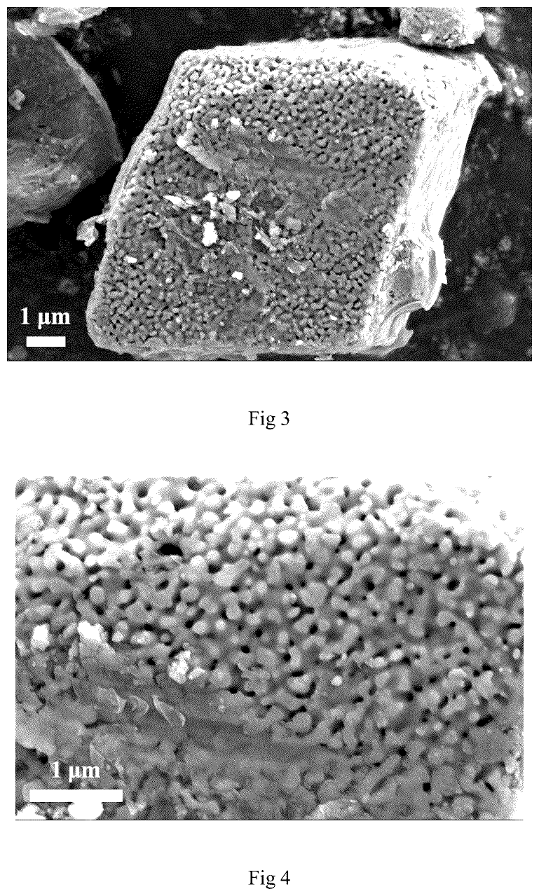

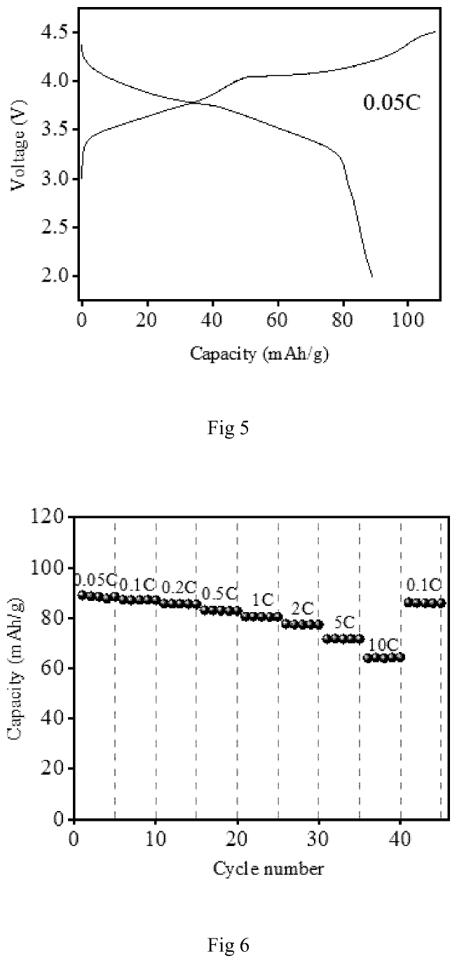

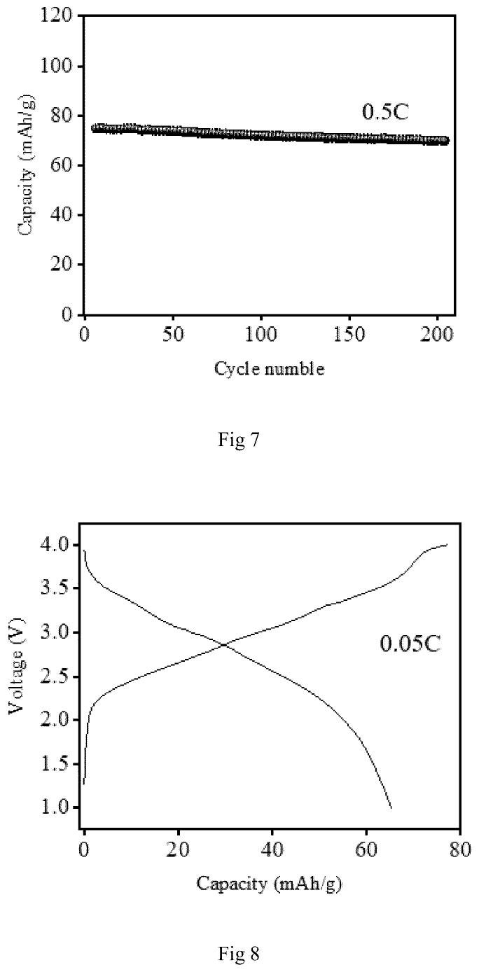

FIG. 1 shows the X-ray diffraction (XRD) pattern of micron-sized porous sodium ferrous sulfate/carbon composite positive electrode material corresponding to the standard card (PDF #21-1360) of alluaudite-type Na₂₊₂ₓFe₂₋ₓ(SO₄)₃ with good crystallinity. The diffraction peak (2 theta=32°) exhibits the highest intensity, indicating that the (240) plane is the dominant facet of sodium ferrous sulfate crystals. FIG. 2 shows the SEM image of the precursor, which has a relatively regular polyhedral shape. FIG. 3 shows the SEM image of the micron-sized porous sodium ferrous sulfate/carbon composite positive electrode material with dispersed and unaggregated composite particle clusters. The length range of the sodium ferrous sulfate/carbon composite particles is about 5-7 μm, in which the small particles are piled up with each other to form a bulk structure with abundant porous. Graphene thin layer with a size range of 1-8 μm were wrapped on the surface of the secondary sodium ferrous sulfate particles. FIG. 4 shows the high-resolution SEM image of the micron-sized porous sodium ferrous sulfate/carbon composite positive electrode material, the particle of the sodium ferrous sulfate primary particles is uniformly distributed, with the size of 80-200 nm, and the amorphous carbon is uniformly wrapped around the sodium ferrous sulfate primary particles. Among them, the total amount of graphene/carbon is 12.3% of the mass of sodium ferrous sulfate composite. The prepared micron-sized porous sodium ferrous sulfate/carbon composite positive electrode material was used as the active material of the positive electrode. The active material was mixed with acetylene black and polyvinylidene fluoride in the mass ratio of 70:20:10, the above mixture was mixed well and blended into a slurry and coated onto an aluminum foil by employing 1-methyl-2-pyrrolidone as the dispersant. After vacuum drying at 120° C., the foil was cut to obtain a positive electrode sheet with a diameter of 13 mm, a sodium metal sheet as the negative electrode (16 mm in diameter), a glass fiber membrane (Whatman GF/D) as the separatoe, and an electrolyte used the solution of 1M NaClO₄ dissolved in EC:PC (1:1 by volume) with 5 wt. % FEC additive. The stainless steel was used as the outer shell and assembled into a CR2025 type coin cell. The sodium battery assembled by the above process was tested for charge and discharge in the potential range of 2.0-4.5 V at room temperature, its charge and discharge curves, rate performance and cycling performance are shown in FIGS. 5, 6 and 7. The discharged plateau was around 3.8 V at 0.05 C, with a specific capacity of 89 mAh/g, the discharge energy density of the battery reachs 320 Wh/kg (based on the mass of the positive electrode active material). At a large rate of 10 C, its discharged specific capacity can reach 64 mAh/g, and the positive electrode still maintains a specific capacity of 70 mAh/g after 200 cycles of cycling at 0.5 C (1 C=120 mA/g).

### Example 2

The preparation of micron-sized porous sodium ferrous sulfate/carbon composite positive electrode material of this embodiment is the same as that of Example 1.

The prepared micron-sized porous sodium ferrous sulfate/carbon composite positive electrode material was used as the active material of the positive electrode, hard carbon was used as the active material of the negative electrode. The positive electrode material was mixed with acetylene black and polyvinylidene fluoride in the mass ratio of 70:20:10, by employing 1-methyl-2-pyrrolidone as the dispersant; the negative electrode active material was mixed with acetylene black and sodium carboxymethyl cellulose (CMC) at a mass ratio of 80:10:10, deionized water was used as the dispersant; the above mixture was mixed uniformly and blended into a slurry and coated onto the aluminum foil and copper foil, respectively, then vacuum-dried and sheared at 120° C. to obtain the corresponding positive electrode and negative electrode pieces. The positive electrode and negative electrode were separated by a glass fiber film (Whatman GF/D), and a pouch cell was assembled using 1M NaClO₄ dissolved in EC:PC (1:1 by volume) (5 wt. % FEC additive) as the electrolyte and an aluminum-plastic film as the shell. The sodium ion battery assembled by the above process was subjected to constant-current charge/discharge test at room temperature in the potential range of 1.0-4.0 V. The charge/discharge curve is shown in FIG. 8. The discharged plateau is around 2.8 V at 0.05 C, its discharged specific capacity can reach 65 mAh/g.

### Example 3

The preparation of micron-sized porous sodium ferrous sulfate/carbon composite positive electrode material of this embodiment is the same as that of Example 1.

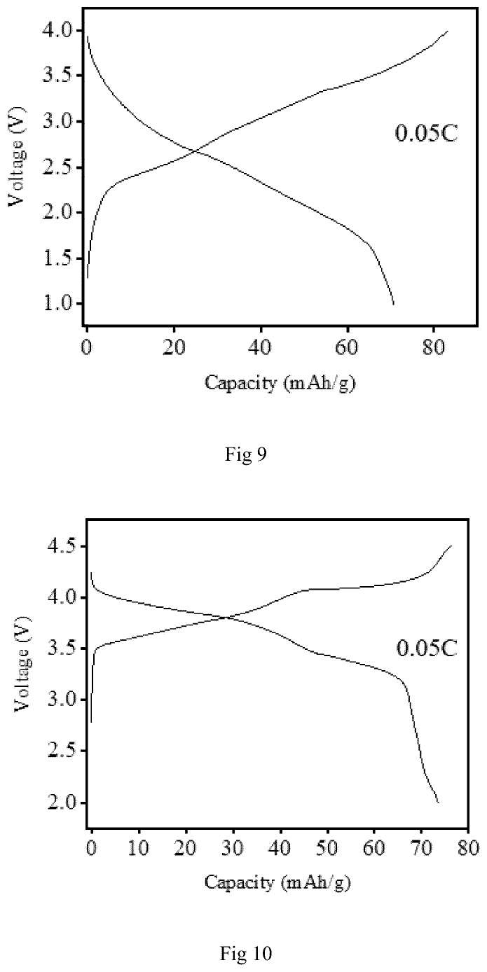

The prepared micron-sized porous sodium ferrous sulfate/carbon composite positive electrode material was used as the positive electrode active material, ferrous sulfide/carbon composites as an negative electrode active material. The positive electrode material was mixed with acetylene black and polyvinylidene fluoride in the mass ratio of 70:20:10, by employing 1-methyl-2-pyrrolidone as the dispersant; the negative electrode active material was mixed with acetylene black and sodium carboxymethyl cellulose (CMC) at a mass ratio of 80:10:10, deionized water was used as the dispersant; the above mixture was mixed uniformly and blended into a slurry and coated onto the aluminum foil and copper foil, respectively, then vacuum-dried and sheared at 120° C. to obtain the corresponding positive electrode and negative electrode pieces. The positive electrode and negative electrode were separated by a glass fiber film (Whatman GF/D), and a pouch cell was assembled using 1M NaClO₄ dissolved in EC:PC (1:1 by volume) (5 wt. % FEC additive) as the electrolyte and an aluminum-plastic film as the shell. The sodium ion battery assembled by the above process was subjected to constant-current charge/discharge test at room temperature in the potential range of 1.0-4.0 V. The charge/discharge curve is shown in FIG. 9. The discharged plateau is around 2.6 V at 0.05 C, its discharged specific capacity can reach 72 mAh/g.

### Example 4

The preparation of micron-sized porous sodium ferrous sulfate/carbon composite positive electrode material of this embodiment is the same as that of Example 1.

The micron-sized porous sodium ferrous sulfate/carbon composite positive electrode material prepared in Example 1 was used as the positive electrode active material, the positive electrode material was mixed with acetylene black and polyvinylidene fluoride in the mass ratio of 70:20:10, the above mixture was mixed well and blended into a slurry and coated onto an aluminum foil by employing 1-methyl-2-pyrrolidone as the dispersant. After vacuum drying at 120° C., the foil was cut to obtain a positive electrode sheet with a diameter of 13 mm, a sodium metal sheet as the negative electrode (16 mm in diameter), a glass fiber membrane (Whatman GF/D) as the separator, and an electrolyte using 1M NaClO₄ dissolved in EC:PC (1:1 by volume) (5 wt. % FEC additive). The stainless steel was used as the outer shell and assembled into a CR2025 type coin cell. The sodium battery assembled by the above process was tested for charge and discharge in the potential range of 2.0-4.5 V at room temperature. Its charge/discharge curves is shown in FIG. 10. The discharged plateau is around 3.8 V at 0.05 C, its discharged specific capacity is 73 mAh/g.

### Example 5

The synthesis steps of the micron-sized porous sodium ferrous sulfate/carbon composite positive electrode material are as follows: 0.01 g of dry graphene oxide powder was dispersed into the mixture of 20 mL of deionized water and 10 ml of ethylene glycol. The solution was stirred for 1 h, and ultrasonicated for 15 min to disperse the graphene oxide. 1.112 g of ferrous sulfate heptahydrate (FeSO₄·7H₂O), 0.5682 g of anhydrous sodium sulfate (Na₂SO₄), 0.2 g of citric acid monohydrate, 0.02 g of ascorbic acid were dissolved in the above graphene oxide dispersion, and stirred for 1 h at room temperature (25° C.). 40 mL of isopropanol was added dropwise to the above solution to obtain a turbid suspension, and the suspension was stirred for another 1 h. The turbid suspension was centrifuged (centrifugation rate of 9000 r/min, centrifugation time of 3 min), the obtained solid was frozen by liquid nitrogen and then freeze-dried for 36 h to obtain the precursor. The precursor was ground uniformly, transferred to a ceramic cup, and placed in a tube furnace with argon atmosphere at a heating rate of 3° C./min to 200° C. for 2 h, adjusted the heating rate of 1° C./min, and then heated to 350° C. for 12 h, to obtain the micron-sized porous sodium ferrous sulfate/carbon composite positive electrode materials.

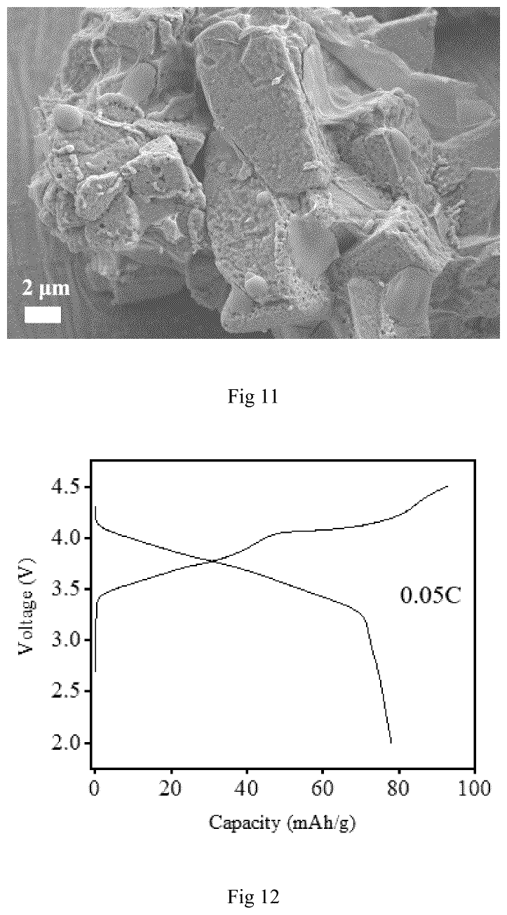

FIG. 11 shows the SEM image of the micron-sized porous sodium ferrous sulfate/carbon composite positive electrode material prepared in the present embodiment, with abundant pores present within the composite particles, and a thin layer of graphene apparently covering the surface of the secondary sodium ferrous sulfate particles. The micron-sized porous sodium ferrous sulfate/carbon composite positive electrode material prepared in this embodiment was utilized as the active material of the positive electrode, sodium metal was used as the negative electrode. The battery was prepared as in Example 1. The sodium battery assembled by the above process was tested for charge and discharge in the potential range of 2.0-4.5 V at room temperature. The charge/discharge curve is shown in FIG. 12. The discharged plateau is around 3.8 V at 0.05 C, its discharged specific capacity is 78 mAh/g.

### Example 6

The synthesis steps of the micron-sized porous sodium ferrous sulfate/carbon composite positive electrode material are as follows: 0.02 g of dry graphene oxide powder was dispersed into the mixture of 20 mL of deionized water and 5 mL of ethylene glycol. The solution was stirred for 30 min, and ultrasonicated for 1 h to disperse the graphene oxide. 1.112 g of ferrous sulfate heptahydrate (FeSO₄·7H₂O), 0.5682 g of anhydrous sodium sulfate (Na₂SO₄), 0.2 g of citric acid monohydrate, 0.02 g of ascorbic acid were dissolved in the above graphene oxide dispersion, and stirred for 1 h at room temperature (25° C.). 40 mL of isopropanol was added dropwise to the above solution to obtain a turbid suspension, and the suspension was stirred for another 1 h. The turbid suspension was centrifuged (centrifugation rate of 8500 r/min, centrifugation time of 3 min), the obtained solid was frozen by liquid nitrogen and then freeze-dried for 36 h to obtain the precursor. The precursor was ground uniformly, transferred to a ceramic cup, and placed in a tube furnace with argon atmosphere at a heating rate of 3° C./min to 200° C. for 2 h, adjusted the heating rate of 1° C./min, and then heated to 350° C. for 12 h, to obtain the micron-sized porous sodium ferrous sulfate/carbon composite positive electrode materials.

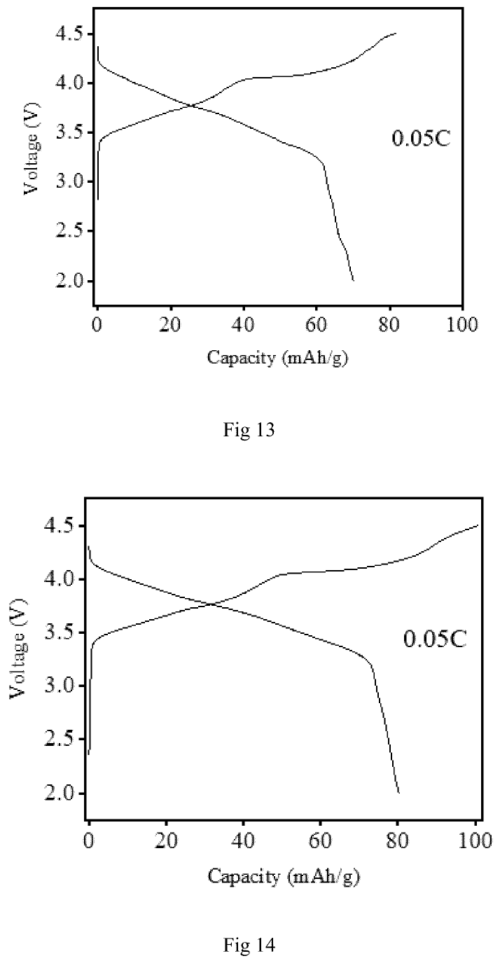

The micron-sized porous sodium ferrous sulfate/carbon composite positive electrode material prepared in this embodiment was utilized as the active material of the positive electrode, sodium metal was used as the negative electrode. The battery was prepared as in Example 1. The sodium battery assembled by the above process was tested for charge and discharge in the potential range of 2.0-4.5 V at room temperature. The charge/discharge curve is shown in FIG. 13. The discharged plateau is around 3.8 V at 0.05 C, its discharged specific capacity is 70 mAh/g.

### Example 7

The synthesis steps of the micron-sized porous sodium ferrous sulfate/carbon composite positive electrode material are as follows: 0.02 g of dry graphene oxide powder was dispersed into the mixture of 20 mL of deionized water and 10 ml of ethylene glycol. The solution was stirred for 15 min, and ultrasonicated for 1 h to disperse the graphene oxide. 1.112 g of ferrous sulfate heptahydrate (FeSO₄·7H₂O), 0.5682 g of anhydrous sodium sulfate (Na₂SO₄), 0.1 g of citric acid monohydrate, 0.02 g of ascorbic acid were dissolved in the above graphene oxide dispersion, and stirred for 1 h at room temperature (25° C.). 40 mL of isopropanol was added dropwise to the above solution to obtain a turbid suspension, and the suspension was stirred for another 1 h. The turbid suspension was centrifuged (centrifugation rate of 8500 r/min, centrifugation time of 3 min), the obtained solid was frozen by liquid nitrogen and then freeze-dried for 36 h to obtain the precursor. The precursor was ground uniformly, transferred to a ceramic cup, and placed in a tube furnace with argon atmosphere at a heating rate of 3° C./min to 200° C. for 2 h, adjusted the heating rate of 1° C./min, and then heated to 350° C. for 12 h, to obtain the micron-sized porous sodium ferrous sulfate/carbon composite positive electrode materials.

The micron-sized porous sodium ferrous sulfate/carbon composite positive electrode material prepared in this embodiment was utilized as the active material of the positive electrode, sodium metal was used as the negative electrode. The battery was prepared as in Example 1. The sodium battery assembled by the above process was tested for charge and discharge in the potential range of 2.0-4.5 V at room temperature. The charge/discharge curve is shown in FIG. 14. The discharged plateau is around 3.8 V at 0.05 C, its discharged specific capacity is 80 mAh/g.

### Example 8

The synthesis steps of the micron-sized porous sodium ferrous sulfate/carbon composite positive electrode material are as follows: 0.02 g of dry graphene oxide powder was dispersed into the mixture of 20 mL of deionized water and 10 ml of ethylene glycol. The solution was stirred for 15 min, and ultrasonicated for 1 h to disperse the graphene oxide. 1.112 g of ferrous sulfate heptahydrate (FeSO₄·7H₂O), 0.5682 g of anhydrous sodium sulfate (Na₂SO₄), 0.1 g of citric acid monohydrate, 0.02 g of ascorbic acid were dissolved in the above graphene oxide dispersion, and stirred for 1 h at room temperature (25° C.). 40 mL of isopropanol was added dropwise to the above solution to obtain a turbid suspension, and the suspension was stirred for another 1 h. The turbid suspension was centrifuged (centrifugation rate of 9000 r/min, centrifugation time of 3 min), the obtained solid was frozen by liquid nitrogen and then freeze-dried for 36 h to obtain the precursor. The precursor was ground uniformly, transferred to a ceramic cup, and placed in a tube furnace with argon atmosphere at a heating rate of 3° C./min to 200° C. for 2 h, adjusted the heating rate of 1° C./min, and then heated to 350° C. for 12 h, to obtain the micron-sized porous sodium ferrous sulfate/carbon composite positive electrode materials.

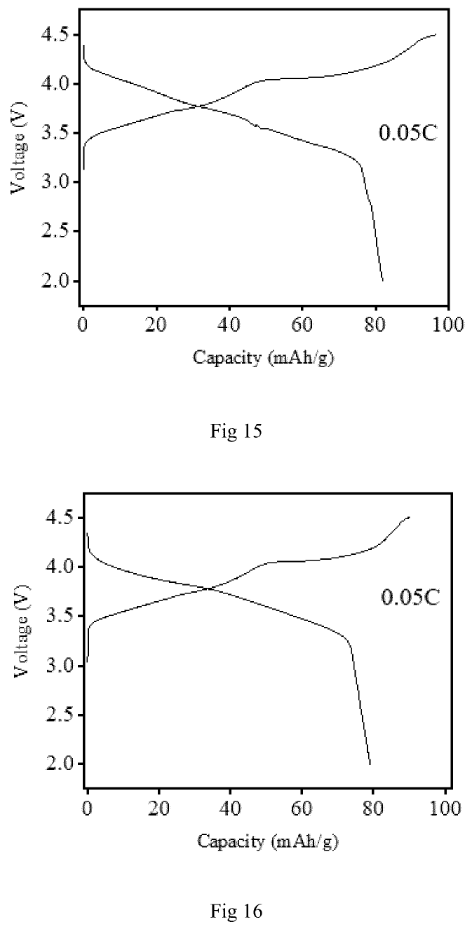

The micron-sized porous sodium ferrous sulfate/carbon composite positive electrode material prepared in this embodiment was utilized as the active material of the positive electrode, sodium metal was used as the negative electrode. The battery was prepared as in Example 1. The sodium battery assembled by the above process was tested for charge and discharge in the potential range of 2.0-4.5 V at room temperature. The charge/discharge curve is shown in FIG. 15. The discharged plateau is around 3.8 V at 0.05 C, its discharged specific capacity is 82 mAh/g.

### Example 9

The synthesis steps of the micron-sized porous sodium ferrous sulfate/carbon composite positive electrode material are as follows: 0.02 g of dry graphene oxide powder was dispersed into the mixture of 20 mL of deionized water and 10 mL of ethylene glycol. The solution was stirred for 15 min, and ultrasonicated for 1 h to disperse the graphene oxide. 1.112 g of ferrous sulfate heptahydrate (FeSO₄·7H₂O), 0.5682 g of anhydrous sodium sulfate (Na₂SO₄), 0.1 g of citric acid monohydrate, 0.02 g of ascorbic acid were dissolved in the above graphene oxide dispersion, and stirred for 1 h at room temperature (25° C.). 40 mL of isopropanol was added dropwise to the above solution to obtain a turbid suspension, and the suspension was stirred for another 1 h. The turbid suspension was centrifuged (centrifugation rate of 9000 r/min, centrifugation time of 3 min), the obtained solid was frozen by liquid nitrogen and then freeze-dried for 36 h to obtain the precursor. The precursor was ground uniformly, transferred to a ceramic cup, and placed in a tube furnace with argon atmosphere at a heating rate of 3° C./min to 200° C. for 2 h, adjusted the heating rate of 1° C./min, and then heated to 350° C. for 24 h, to obtain the micron-sized porous sodium ferrous sulfate/carbon composite positive electrode materials.

The micron-sized porous sodium ferrous sulfate/carbon composite positive electrode material prepared in this embodiment was utilized as the active material of the positive electrode, sodium metal was used as the negative electrode. The battery was prepared as in Example 1. The sodium battery assembled by the above process was tested for charge and discharge in the potential range of 2.0-4.5 V at room temperature. The charge/discharge curve is shown in FIG. 16. The discharged plateau is around 3.8 V at 0.05 C, its discharged specific capacity is 79 mAh/g.

### Example 10

The synthesis steps of the micron-sized porous sodium ferrous sulfate/carbon composite positive electrode material are as follows: 0.02 g of dry graphene oxide powder was dispersed into the mixture of 20 mL of deionized water and 10 ml of ethylene glycol. The solution was stirred for 1 h, and ultrasonicated for 1 h to disperse the graphene oxide. 1.112 g of ferrous sulfate heptahydrate (FeSO₄·7H₂O), 0.5682 g of anhydrous sodium sulfate (Na₂SO₄), 0.1 g of polyethylene glycol, 0.02 g of ascorbic acid were dissolved in the above graphene oxide dispersion, and stirred for 1 h at room temperature (25° C.). 40 mL of isopropanol was added dropwise to the above solution to obtain a turbid suspension, and the suspension was stirred for another 1 h. The turbid suspension was centrifuged (centrifugation rate of 9000 r/min, centrifugation time of 5 min), the obtained solid was frozen by liquid nitrogen and then freeze-dried for 36 h to obtain the precursor. The precursor was ground uniformly, transferred to a ceramic cup, and placed in a tube furnace with argon atmosphere at a heating rate of 3° C./min to 200° C. for 2 h, adjusted the heating rate of 1° C./min, and then heated to 350° C. for 12 h, to obtain the micron-sized porous sodium ferrous sulfate/carbon composite positive electrode materials.

The micron-sized porous sodium ferrous sulfate/carbon composite positive electrode material prepared in this embodiment was utilized as the active material of the positive electrode, sodium metal was used as the negative electrode. The battery was prepared as in Example 1. The sodium battery assembled by the above process was tested for charge and discharge in the potential range of 2.0-4.5 V at room temperature. The discharged plateau is around 3.7 V at 0.05 C, its discharged specific capacity is 74 mAh/g.

### Example 11

The synthesis steps of the micron-sized porous sodium ferrous sulfate/carbon composite positive electrode material are as follows: 0.02 g of dry graphene oxide powder was dispersed into the mixture of 20 mL of deionized water and 10 mL of ethylene glycol. The solution was stirred for 1 h, and ultrasonicated for 1 h to disperse the graphene oxide. 1.112 g of ferrous sulfate heptahydrate (FeSO₄·7H₂O), 0.5682 g of anhydrous sodium sulfate (Na₂SO₄), 0.2 g of polyethylene glycol, 0.02 g of ascorbic acid were dissolved in the above graphene oxide dispersion, and stirred for 1 h at room temperature (25° C.). 40 mL of n-butyl alcohol was added dropwise to the above solution to obtain a turbid suspension, and the suspension was stirred for another 1 h. The turbid suspension was centrifuged (centrifugation rate of 9000 r/min, centrifugation time of 5 min), the obtained solid was frozen by liquid nitrogen and then freeze-dried for 36 h to obtain the precursor. The precursor was ground uniformly, transferred to a ceramic cup, and placed in a tube furnace with argon atmosphere at a heating rate of 3° C./min to 200° C. for 2 h, adjusted the heating rate of 1° C./min, and then heated to 350° C. for 12 h, to obtain the micron-sized porous sodium ferrous sulfate/carbon composite positive electrode materials.

The micron-sized porous sodium ferrous sulfate/carbon composite positive electrode material prepared in this embodiment was utilized as the active material of the positive electrode, sodium metal was used as the negative electrode. The battery was prepared as in Example 1. The sodium battery assembled by the above process was tested for charge and discharge in the potential range of 2.0-4.5 V at room temperature. The discharged plateau is around 3.6 V at 0.05 C, its discharged specific capacity is 80 mAh/g.

### Example 12

The synthesis steps of the micron-sized porous sodium ferrous sulfate/carbon composite positive electrode material are as follows: 0.02 g of dry graphene oxide powder was dispersed into the mixture of 20 mL of deionized water and 10 ml of ethylene glycol. The solution was stirred for 1 h, and ultrasonicated for 15 min to disperse the graphene oxide. 1.0564 g of ferrous sulfate heptahydrate (FeSO₄·7H₂O), 0.0889 g of aluminium sulfate octadecahydrate, 0.5682 g of anhydrous sodium sulfate (Na₂SO₄), 0.2 g of polyethylene glycol, 0.02 g of ascorbic acid were dissolved in the above graphene oxide dispersion, and stirred for 1 h at room temperature (25° C.). 40 mL of n-butyl alcohol was added dropwise to the above solution to obtain a turbid suspension, and the suspension was stirred for another 1 h. The turbid suspension was centrifuged (centrifugation rate of 9000 r/min, centrifugation time of 3 min), the obtained solid was frozen by liquid nitrogen and then freeze-dried for 36 h to obtain the precursor. The precursor was ground uniformly, transferred to a ceramic cup, and placed in a tube furnace with argon atmosphere at a heating rate of 3° C./min to 200°C. for 2 h, adjusted the heating rate of 1° C./min, and then heated to 350° C. for 12 h, to obtain the micron-sized porous sodium ferrous sulfate/carbon composite positive electrode materials.

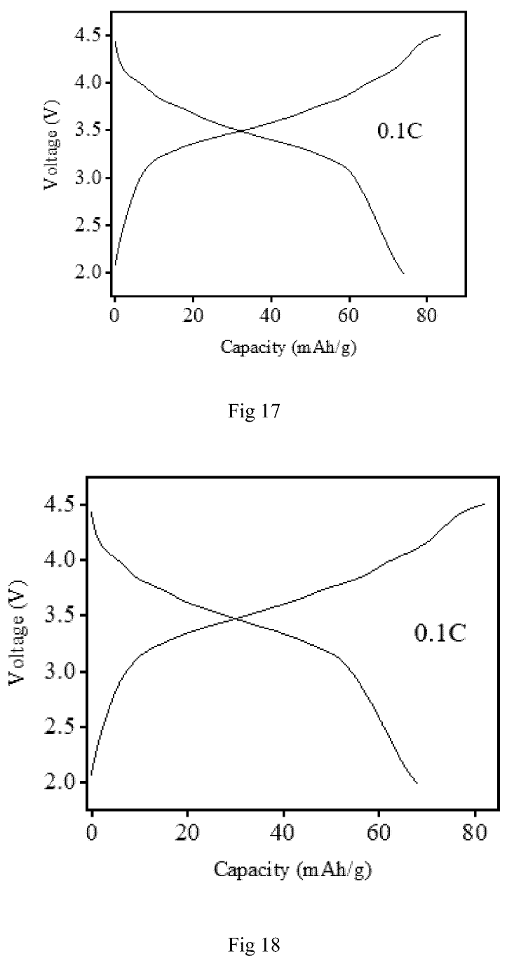

The micron-sized porous sodium ferrous sulfate/carbon composite positive electrode material prepared in this embodiment was utilized as the active material of the positive electrode, sodium metal was used as the negative electrode. The battery was prepared as in Example 1. The sodium battery assembled by the above process was tested for charge and discharge in the potential range of 2.0-4.5 V at room temperature. The charge/discharge curve is shown in FIG. 17. After 30 cycles at 0.1 C, its discharged specific capacity reaches 74 mAh/g with a discharged plateau around 3.5 V.

### Example 13

The synthesis steps of the micron-sized porous sodium ferrous sulfate/carbon composite positive electrode material are as follows:
0.02 g of dry graphene oxide powder was dispersed into the mixture of 20 ml of deionized water and 10 mL of ethylene glycol. The solution was stirred for 1 h, and ultrasonicated for 15 min to disperse the graphene oxide. 1.0564 g of ferrous sulfate heptahydrate (FeSO₄·7H₂O), 0.0499 g copper sulfate pentahydrate, 0.5682 g of anhydrous sodium sulfate (Na₂SO₄), 0.2 g of citric acid monohydrate, 0.02 g of ascorbic acid were dissolved in the above graphene oxide dispersion, and stirred for 1 h at room temperature (25° C.). 40 mL of isopropanol was added dropwise to the above solution to obtain a turbid suspension, and the suspension was stirred for another 1 h. The turbid suspension was centrifuged (centrifugation rate of 9000 r/min, centrifugation time of 3 min), the obtained solid was frozen by liquid nitrogen and then freeze-dried for 36 h to obtain the precursor. The precursor was ground uniformly, transferred to a ceramic cup, and placed in a tube furnace with argon atmosphere at a heating rate of 3° C./min to 200° C. for 2 h, adjusted the heating rate of 1° C./min, and then heated to 350° C. for 12 h, to obtain the micron-sized porous sodium ferrous sulfate/carbon composite positive electrode materials.

The micron-sized porous sodium ferrous sulfate/carbon composite positive electrode material prepared in this embodiment was utilized as the active material of the positive electrode, sodium metal was used as the negative electrode. The battery was prepared as in Example 1. The sodium battery assembled by the above process was tested for charge and discharge in the potential range of 2.0-4.5 V at room temperature. The charge/discharge curve is shown in FIG. 18. After 30 cycles at 0.1 C, its discharged specific capacity reaches 67 mAh/g with a discharged plateau around 3.6 V.

The above is only a preferred embodiment of the present invention, and is not intended to limit the present invention, and any modifications, equivalent substitutions, improvements, etc. made within the spirit and principles of the present invention shall be included in the scope of protection of the present invention.

1-10. (canceled)

11. A micron-sized porous sodium ferrous sulfate/carbon composite positive electrode material, characterised in that the micron-sized porous sodium ferrous sulfate/carbon composite positive electrode materials have a particle size range of 2-30 μm. The particles have a porous structure, consist of 80-200 nm primary nanoparticles tightly stacked together; the primary nanoparticles are tightly wrapped by an amorphous carbon, and the surface layer of the particles is covered by a thin layer of reduced graphene covered by a thin layer of reduced graphene on the surface of the particles, the total mass of graphene/carbon in the micron-sized porous sodium ferrous sulfate/carbon composite positive electrode material is 4%-18.5%;
and the sodium ferrous sulfate/carbon composite positive electrode material can be doped with a metal element within the sodium ferrous sulfate, the doped metal element is Co, Ni, Mn, Cu, or Al;
the included preparation steps are following:
(1) The precursor was prepared by the co-precipitation method: a certain proportion of ethylene glycol and graphene oxide powder were dispersed into deionized water, and ultrasonicated for 15-120 min, then a certain proportion of anhydrous sodium sulfate, ferrous sulfate heptahydrate, antioxidant, organic carbon source and metal dopant were added, and stirred for 30-120 min. The organic alcohols were added drop by drop, and stirred for 10-120 min, then the obtained turbid solution was centrifuged and freeze-dried to obtain the precursor; the organic alcohols were one or more of isopropanol, anhydrous ethanol, n-butanol, tertiary-butanol, propyltriethanol and triethylene;
(2) Composite positive electrode materialswere prepared by solid-phase calcination: the precursors obtained in step (1) were ground uniformly and placed in a tube furnace with an inert atmosphere for pre-calcination, then the temperature was raised to 300-450° C. for calcination for 8 -48 h, to obtain micron-sized porous sodium ferrous sulfate/carbon composite positive electrode materials.

12. The method of preparing a micron-sized porous sodium ferrous sulfate/carbon composite positive electrode material according to claim 11, characterised in that: the mass ratio of deionized water, ethylene glycol and graphene oxide in the step (1) is 1000:(200-750):(0.1-1); the molar ratios of anhydrous sodium sulfate, ferrous sulfate heptahydrate, organic carbon source, antioxidant and metal dopant are 1:(0.9-1):(0-0.4):(0.01-0.05):(0-0.1); the organic carbon source is one or more of citric acid monohydrate, glucose, and polyethylene glycol; the metal dopant is one or more of sulfate salts containing metal ions, including manganese sulfate, nickel sulphate, cobalt sulphate, copper sulphate, aluminium sulfate and their hydrates.

13. A micron-sized porous sodium ferrous sulfate/carbon composite positive electrode material according to claim 11, characterised in that: in the step (1), the antioxidant is one or more of ascorbic acid, pyrrole, and hydroquinone; the volume ratio of the organic alcohol to deionized water is (1.5-5.0):1; the centrifugation is at a rate of 6,000-9,500 r/min, the centrifugation is at a time of 1-10 min, and the freeze-drying time is 12-36 h.

14. A micron-sized porous sodium ferrous sulfate/carbon composite positive electrode material according to claim 11, characterised in that: in the step (2), the inert atmosphere is one of nitrogen, argon or argon-hydrogen mixture; the pre-calcination process is to raise the temperature to 100-300° C. at a heating rate of 1-5° C./min for 0.5-3 h; the calcination process is to raise the temperature to 350-400° C. at a heating rate of 1-3° C./min for 8 -48 h.

15. A sodium ion battery or sodium battery prepared using the micron-sized porous sodium ferrous sulfate/carbon composite positive electrode material prepared by the method described in claim 11, comprising a positive electrode sheet, an negative electrode sheet, an electrolyte, a separatoe, and a casing, characterised in the following manner: the micron-sized porous sodium ferrous sulfate/carbon composite positive electrode material is used as the active material of positive electrode, and the active materials with Na⁺ extraction/insertion capability were used as the negative electrode of sodium ion batteries, or sodium metal was used as the negative electrode of sodium batteries. The separator was one of the modified cellulose acetate membranes, polyethylene, polypropylene microporous membranes, glass fiber membranes or their composite membranes, and the electrolyte was soluble sodium salt organic solution.

16. The sodium ion battery or sodium battery according to claim 15, characterised in that: the positive electrode sheet of the sodium batteries is obtained by filling and coating the collector with a slurry obtained by uniformly mixing the positive electrode material with the conductive agent, the binder and the dispersant; the collector is aluminum foil. The positive electrode sheet of the sodium ion batteries is obtained by filling and coating the collector with a slurry obtained by uniformly mixing the positive electrode material with the conductive agent, the binder and the dispersant; the collector is aluminum foil; the negative electrode sheet is obtained by filling and coating the collector with a slurry obtained by uniformly mixing the negative electrode material with the conductive agent, the binder and the dispersant, the collector being aluminum foil or copper foil.

17. The sodium ion battery or sodium battery according to claim 16, characterised in that: the conductive agent of the sodium ion batteries or the sodium batteries is one or more of acetylene black, Super P, or graphite; the binder of the sodium ion batteries or the sodium batteries is one or more of polytetrafluoroethylene, polyvinylidene fluoride, or styrene-butadiene rubber; the dispersant of the sodium ion batteries or the sodium batteries is one or more of anhydrous ethanol, isopropanol, or 1-methyl-2-pyrrolidone.

18. The sodium ion battery or sodium battery according to claim 17, characterised in that: the negative electrode of the sodium ion batteries is an active material with with Na⁺ extraction/insertion capability, including carbon materials, metal sulfides, metal oxides, and alloy compounds; the soluble sodium salt organic solution is obtained by dissolving the sodium salt in organic solvents, the sodium salt is one or more of sodium hexafluorophosphate, sodium perchlorate, and sodium trifluoromethyl sulfonate, the organic solvent is one or more of ethylene carbonate (EC), propylene carbonate (PC), fluoroethylene carbonate (FEC), dimethyl carbonate, diethyl carbonate, diglycol dimethyl ether, 1,3-cyclopentanediol, ethylene glycol dimethyl ether, and triglycerol dimethyl ether.

19. A sodium ion battery or sodium battery prepared using the micron-sized porous sodium ferrous sulfate/carbon composite positive electrode material prepared by the method described in claim 12, comprising a positive electrode sheet, an negative electrode sheet, an electrolyte, a separatoe, and a casing, characterised in the following manner: the micron-sized porous sodium ferrous sulfate/carbon composite positive electrode material is used as the active material of positive electrode, and the active materials with Na⁺ extraction/insertion capability were used as the negative electrode of sodium ion batteries, or sodium metal was used as the negative electrode of sodium batteries. The separator was one of the modified cellulose acetate membranes, polyethylene, polypropylene microporous membranes, glass fiber membranes or their composite membranes, and the electrolyte was soluble sodium salt organic solution.

20. The sodium ion battery or sodium battery according to claim 19, characterised in that: the positive electrode sheet of the sodium batteries is obtained by filling and coating the collector with a slurry obtained by uniformly mixing the positive electrode material with the conductive agent, the binder and the dispersant; the collector is aluminum foil. The positive electrode sheet of the sodium ion batteries is obtained by filling and coating the collector with a slurry obtained by uniformly mixing the positive electrode material with the conductive agent, the binder and the dispersant; the collector is aluminum foil; the negative electrode sheet is obtained by filling and coating the collector with a slurry obtained by uniformly mixing the negative electrode material with the conductive agent, the binder and the dispersant, the collector being aluminum foil or copper foil.

21. The sodium ion battery or sodium battery according to claim 20, characterised in that: the conductive agent of the sodium ion batteries or the sodium batteries is one or more of acetylene black, Super P, or graphite; the binder of the sodium ion batteries or the sodium batteries is one or more of polytetrafluoroethylene, polyvinylidene fluoride, or styrene-butadiene rubber; the dispersant of the sodium ion batteries or the sodium batteries is one or more of anhydrous ethanol, isopropanol, or 1-methyl-2-pyrrolidone.

22. The sodium ion battery or sodium battery according to claim 21, characterised in that: the negative electrode of the sodium ion batteries is an active material with with Na⁺ extraction/insertion capability, including carbon materials, metal sulfides, metal oxides, and alloy compounds; the soluble sodium salt organic solution is obtained by dissolving the sodium salt in organic solvents, the sodium salt is one or more of sodium hexafluorophosphate, sodium perchlorate, and sodium trifluoromethyl sulfonate, the organic solvent is one or more of ethylene carbonate (EC), propylene carbonate (PC), fluoroethylene carbonate (FEC), dimethyl carbonate, diethyl carbonate, diglycol dimethyl ether, 1,3-cyclopentanediol, ethylene glycol dimethyl ether, and triglycerol dimethyl ether.

23. A sodium ion battery or sodium battery prepared using the micron-sized porous sodium ferrous sulfate/carbon composite positive electrode material prepared by the method described in claim 13, comprising a positive electrode sheet, an negative electrode sheet, an electrolyte, a separatoe, and a casing, characterised in the following manner: the micron-sized porous sodium ferrous sulfate/carbon composite positive electrode material is used as the active material of positive electrode, and the active materials with Na⁺ extraction/insertion capability were used as the negative electrode of sodium ion batteries, or sodium metal was used as the negative electrode of sodium batteries. The separator was one of the modified cellulose acetate membranes, polyethylene, polypropylene microporous membranes, glass fiber membranes or their composite membranes, and the electrolyte was soluble sodium salt organic solution.

24. The sodium ion battery or sodium battery according to claim 23, characterised in that: the positive electrode sheet of the sodium batteries is obtained by filling and coating the collector with a slurry obtained by uniformly mixing the positive electrode material with the conductive agent, the binder and the dispersant; the collector is aluminum foil. The positive electrode sheet of the sodium ion batteries is obtained by filling and coating the collector with a slurry obtained by uniformly mixing the positive electrode material with the conductive agent, the binder and the dispersant; the collector is aluminum foil; the negative electrode sheet is obtained by filling and coating the collector with a slurry obtained by uniformly mixing the negative electrode material with the conductive agent, the binder and the dispersant, the collector being aluminum foil or copper foil.

25. The sodium ion battery or sodium battery according to claim 24, characterised in that: the conductive agent of the sodium ion batteries or the sodium batteries is one or more of acetylene black, Super P, or graphite; the binder of the sodium ion batteries or the sodium batteries is one or more of polytetrafluoroethylene, polyvinylidene fluoride, or styrene-butadiene rubber; the dispersant of the sodium ion batteries or the sodium batteries is one or more of anhydrous ethanol, isopropanol, or 1-methyl-2-pyrrolidone.

26. The sodium ion battery or sodium battery according to claim 25, characterised in that: the negative electrode of the sodium ion batteries is an active material with with Na⁺ extraction/insertion capability, including carbon materials, metal sulfides, metal oxides, and alloy compounds; the soluble sodium salt organic solution is obtained by dissolving the sodium salt in organic solvents, the sodium salt is one or more of sodium hexafluorophosphate, sodium perchlorate, and sodium trifluoromethyl sulfonate, the organic solvent is one or more of ethylene carbonate (EC), propylene carbonate (PC), fluoroethylene carbonate (FEC), dimethyl carbonate, diethyl carbonate, diglycol dimethyl ether, 1,3-cyclopentanediol, ethylene glycol dimethyl ether, and triglycerol dimethyl ether.

27. A sodium ion battery or sodium battery prepared using the micron-sized porous sodium ferrous sulfate/carbon composite positive electrode material prepared by the method described in claim 14, comprising a positive electrode sheet, an negative electrode sheet, an electrolyte, a separatoe, and a casing, characterised in the following manner: the micron-sized porous sodium ferrous sulfate/carbon composite positive electrode material is used as the active material of positive electrode, and the active materials with Na⁺ extraction/insertion capability were used as the negative electrode of sodium ion batteries, or sodium metal was used as the negative electrode of sodium batteries. The separator was one of the modified cellulose acetate membranes, polyethylene, polypropylene microporous membranes, glass fiber membranes or their composite membranes, and the electrolyte was soluble sodium salt organic solution.

28. The sodium ion battery or sodium battery according to claim 27, characterised in that: the positive electrode sheet of the sodium batteries is obtained by filling and coating the collector with a slurry obtained by uniformly mixing the positive electrode material with the conductive agent, the binder and the dispersant; the collector is aluminum foil. The positive electrode sheet of the sodium ion batteries is obtained by filling and coating the collector with a slurry obtained by uniformly mixing the positive electrode material with the conductive agent, the binder and the dispersant; the collector is aluminum foil; the negative electrode sheet is obtained by filling and coating the collector with a slurry obtained by uniformly mixing the negative electrode material with the conductive agent, the binder and the dispersant, the collector being aluminum foil or copper foil.

29. The sodium ion battery or sodium battery according to claim 28, characterised in that: the conductive agent of the sodium ion batteries or the sodium batteries is one or more of acetylene black, Super P, or graphite; the binder of the sodium ion batteries or the sodium batteries is one or more of polytetrafluoroethylene, polyvinylidene fluoride, or styrene-butadiene rubber; the dispersant of the sodium ion batteries or the sodium batteries is one or more of anhydrous ethanol, isopropanol, or 1-methyl-2-pyrrolidone.

30. The sodium ion battery or sodium battery according to claim 29, characterised in that: the negative electrode of the sodium ion batteries is an active material with with Na⁺ extraction/insertion capability, including carbon materials, metal sulfides, metal oxides, and alloy compounds; the soluble sodium salt organic solution is obtained by dissolving the sodium salt in organic solvents, the sodium salt is one or more of sodium hexafluorophosphate, sodium perchlorate, and sodium trifluoromethyl sulfonate, the organic solvent is one or more of ethylene carbonate (EC), propylene carbonate (PC), fluoroethylene carbonate (FEC), dimethyl carbonate, diethyl carbonate, diglycol dimethyl ether, 1,3-cyclopentanediol, ethylene glycol dimethyl ether, and triglycerol dimethyl ether.
